(19) United States
(12) Patent Application Publication
(10) Pub. No.: US 2002/0182437 A1
(43) Pub. Date: Dec. 5, 2002

(54) Coating blade and method for making same

(76) Inventors: Ibrahim Brah Adamou, St-Prex (CH); Silvano Freti, St-Prex (CH)

Correspondence Address: Clifford W Browning, Bank One Center Tower, Suite 3700, 111 Monument Circle, Indianapolis, IN, 46204-5137, US

(21) Appl. No.: 10/111,583

(22) PCT Filed: Oct. 8, 2001
(86) PCT No.: PCT/CH01/00608

(30) Foreign Application Priority Data
Oct. 10, 2000 (EP) 00810931.6

(51) Int. Cl. B05D 1/32; B05D 5/00; B05D 3/00; B05D 1/18; B32B 15/16

(52) U.S. Cl. 428/679; 427/438; 427/180; 427/282; 427/327

(57) ABSTRACT

A coating blade having a covering comprising a nickel-based matrix and particles of ceramic, diamond or carbide dispersed in said matrix, on the functional part of said blade.

The present invention relates to a coating blade and a method for manufacturing a coating blade.

Coating blades used in the paper industry for the manufacture of coated paper generally come in the form of a blade of spring steel, that is to say hardened and tempered steel, 5 cm to 12 cm wide, 0.2 mm to 1 mm thick, with straight or chamfered edges, and with a length which can be up to several meters. Generally mounted in a blade holder, they are intended to provide a regular and constant deposit of a “coating slip” on a paper to be coated, the functional area of the blade, which is the area in contact with the coating slip, which comprises for example a chamfered edge, being placed facing the surface of the strip of paper moving past. The abrasive nature of the constituents of the coating slip leads to wearing of the blade, so that the coat weight varies with time and the deposit becomes irregular, which makes maintaining a constant paper quality difficult. The average life of a steel blade is of the order of 4 to 8 hours. This leads to many machine halts for changing the blade and substantially reduces the operating efficiency.

In order to increase the life of the blades, it has been proposed to cover flexible steel blades with a hard covering on the functional part of the blade, that is to say on the area where it comes into contact with the coating slip. The patent U.S. Pat. No. 4,660,599 describes a blade, the functional part of which is covered by means of a technique for heat spraying of a ceramic covering, for example aluminium oxide or titanium dioxide. The covering is obtained by successive spraying of several coats of particles onto the functional part of a blade strip, which is then divided up into blades.

The patent GB 978,988 describes a creping blade with a covering of ceramic particles, obtained by a technique of flame plating of ceramic particles onto one edge of a steel strip which, after dividing up of the strip into blades, will become the functional part of the blade.

The document GB 1,298,609 also describes a steel creping blade having, close to its functional edge, a ceramic strip deposited in a longitudinal channel by the flame spraying technique.

The document WO 86/07309 describes a coating blade, the functional area of which is covered with a deposit of molybdenum or molybdenum alloy by the flame spraying technique.

The document JP 05192629 describes a coating blade provided by chemical deposition with a nickel-phosphorus (Ni—P) sub-coat, then covered with a hard covering of titanium carbide (TiC).

The aforementioned blades have a life which is distinctly longer than those of steel blades with no covering and can reach around 20 hours. However, examination of papers coated by means of ceramic-covered blades shows coating defects, notably micro-grooves, which is rejected for high quality papers.

Blades chromium plated by electrodeposition are also known. The document JP 03064595 describes a blade provided with a nickel sub-coat, covered with a chromium covering obtained by electrodeposition. These blades also produce coated papers having coating defects, due to the electrodeposition methods, which can be avoided only by an operation for finishing the blades after chromium plating, which increases their production cost.

The object of the document EP 1020542 is the use of deposition solutions comprising quaternary ammonium salts, for performing the chemical co-deposition of nickel-phosphorus and lubricating particles (e.g. PTFE), in order to form composite films 1 μm to 30 μm thick, of uniform appearance.

The aim of the present invention is to offer a coating blade having a long life and which does not cause the coating defects noted with the aforementioned covered blades.

These aims are achieved by means of a blade having a covering comprising a nickel-based matrix and hard particles, consisting of a material of hardness >8 (on the Mohs scale), dispersed in said matrix, on the functional part of said blade. Such a blade can be obtained by a manufacturing method comprising a step of chemical co-deposition of a covering comprising such a nickel-based matrix and such hard particles on the functional part of a steel blade strip.

The hard particles can be particles of diamond, carbides or ceramics.

The blade strip can be submerged in a bath comprising at least a nickel salt, an Ni++ reducing agent and hard particles in suspension which are co-deposited at the same time as a matrix of which nickel is the majority component. Chemical co-deposition, also referred to as electroless deposition, provides a remarkable regularity of the deposit, with no excess thicknesses, notably on the edges of the blade. The coating quality obtained is excellent, similar to that obtained with a new, flexible steel blade, and the paper has no micro-grooves. Moreover, thanks to the hard particles, the wear of the covering is greatly reduced, and the stability over time of the characteristics of the coating is distinctly increased: the life of the blade is close to that of a blade with a covering made entirely of ceramic.

The particles of the covering are preferably chosen from amongst the particles wettable by the deposition bath, inert as regards its chemical constituents and with a surface which is not catalytic (that is to say not suited to the deposition of Ni). The hard particles preferably have diameters between 0.5 μm and 10 μm.

In order to reduce the blade/coating slip/paper friction, there can in addition be co-deposited, in the nickel-based matrix, particles of a solid lubricant, for example polytetrafluoroethylene (PTFE), mixed with the hard particles. To do this, particles of PTFE in suspension are added into the bath. The proportion of particles in the covering varies preferably between 5% and 40% by volume, this proportion being chosen according to application.

Before immersion in the chemical bath, the blade strip may undergo a preparation which may comprise cleaning and/or degreasing and/or brushing and/or electropolishing and/or an anodic attack.

Instead of covering the whole of the blade strip, just the portion in the vicinity of a lateral edge, which will become the functional part of the blade, can be covered, by masking the surfaces which are not intended to be covered. To do this, and in order to minimise the volume of a co-deposition bath, the blade strip can be wound on a support, preferably on a support wheel, forming a helical winding, the turns of this winding being separated from one another by an insert strip consisting of a material inert as regards the constituents of the bath and with a surface which is non-catalytic, so that the nickel is not deposited on top. Preferably, during the co-deposition process, the support is driven with a slow, regulating movement, for example a slow rotation of the wheel around its axis, in order to improve the regularity of the deposit and the uniformity of the distribution of the particles in the matrix. By covering only the functional part, not only is a saving made on reagents, but modification of the elastic properties of the steel strip as a whole is avoided. A strip totally covered over its whole surface could have too large a transverse bending moment for certain applications.

After the co-deposition step, the blade strip or the divided up blades can be subjected to a heat treatment in order to modify the physical properties of the covering, in particular to increase its hardness. This treatment is performed preferably between 290° C. and 650° C.

On the other hand, given the regularity of the deposit obtained by chemical co-deposition, the blade does not require any additional mechanical rectification treatment such as sanding, grinding, etc.

Other characteristics and advantages of the method according to the invention and the blades obtained by this method will become apparent to persons skilled in the art from the detailed description below, in relation to the drawing, in which:

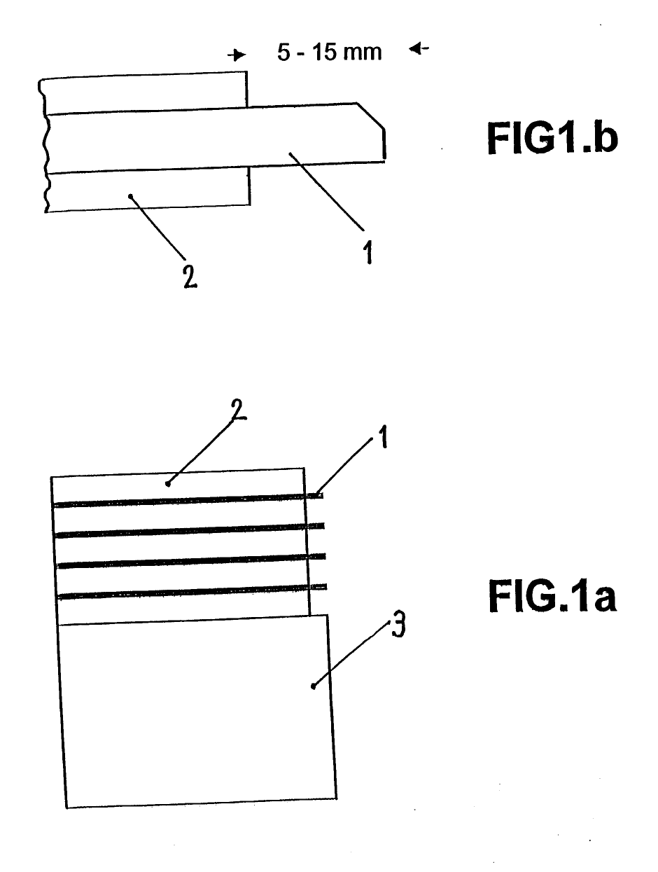

FIGS. 1a and 1b depict schematically and in section respectively a blade strip wound with an insert strip on a support wheel and an enlarged detailed view thereof;

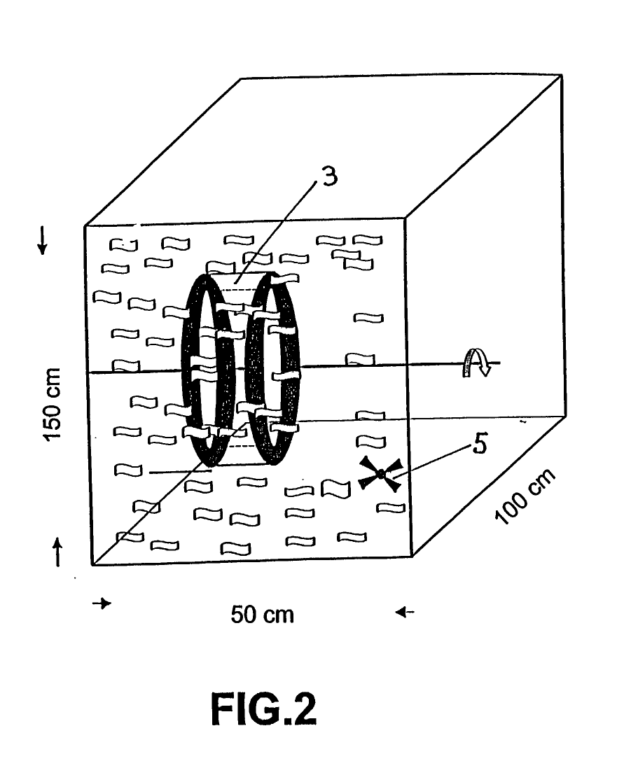

FIG. 2 is a schematic view of the blade strip on its support wheel, submerged in a chemical co-deposition bath;

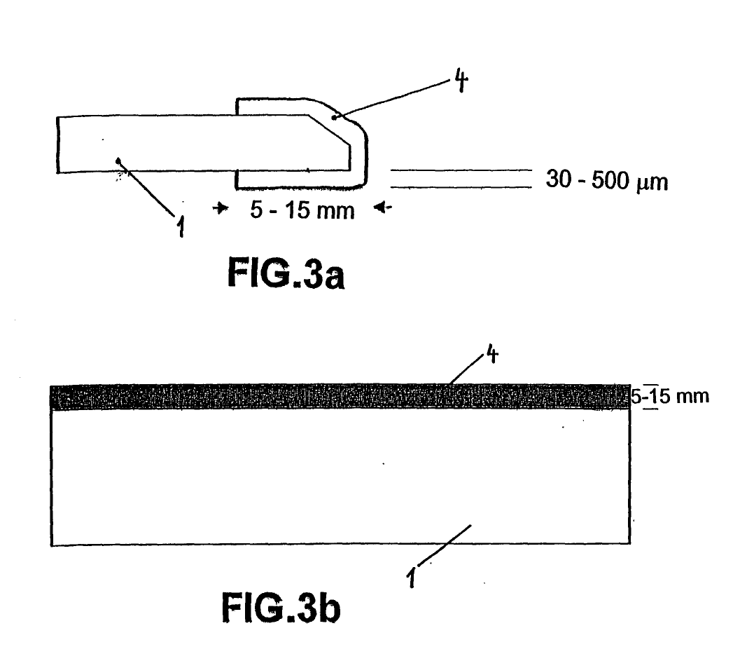

FIGS. 3a and 3b depict respectively a sectional view and a top view of a covered blade segment;

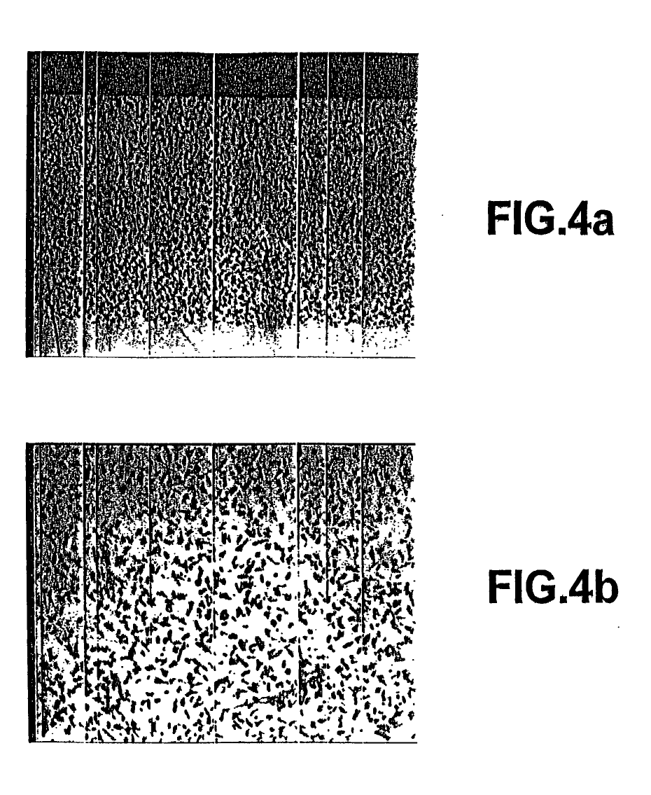

FIGS. 4a and 4b are two microphotographs of a covered blade at the respective magnifications of 100 times and 200 times;

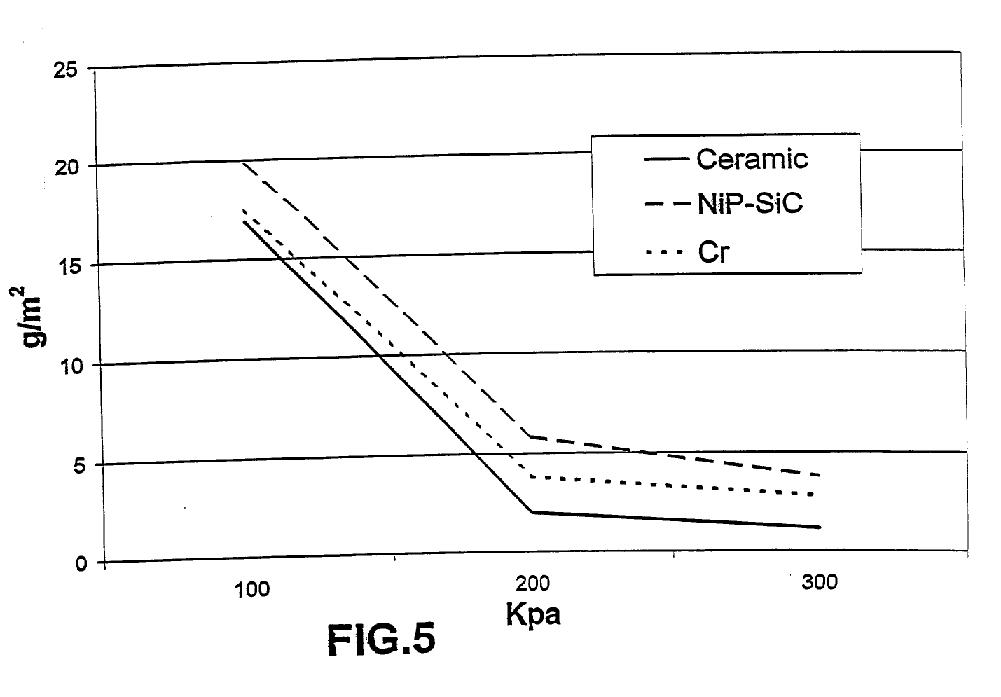

FIG. 5 shows comparative performances of three types of blade;

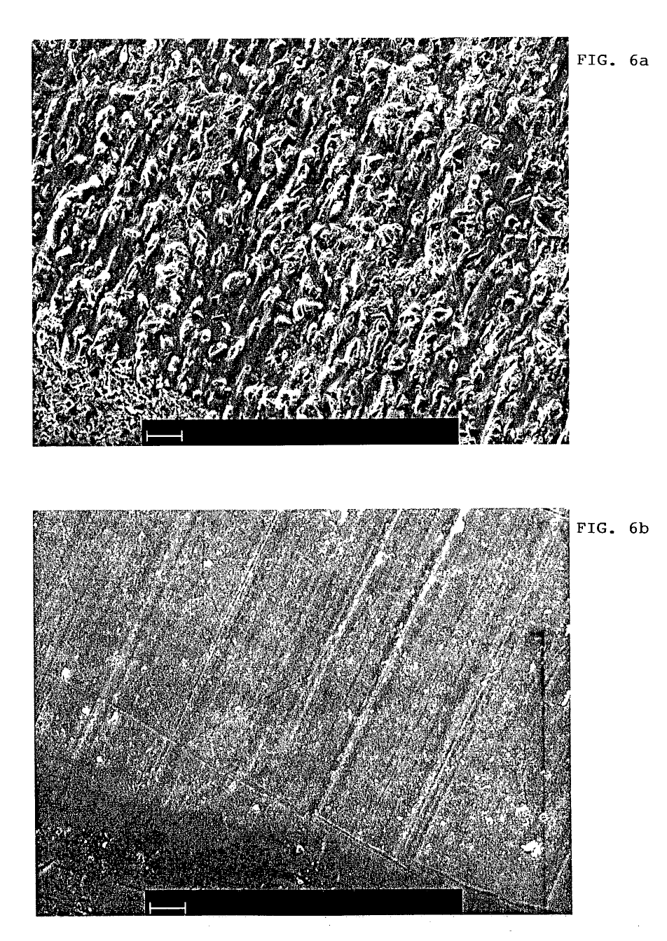

FIGS. 6a and 6b show microphotographs at a magnification of 500 (the calibration bar represents 5 μm) respectively of a blade according to the invention and a chromium plated blade, worn by a paper production test.

The method according to the invention uses the controlled reduction of Ni++ on a catalytic surface by a reducing agent, with no electric current and therefore with no electrolytic reaction, the energy for the reaction being supplied by the heat of the bath. The reducing agent is preferably a hypophosphite, an aminoborane or a borohydride, so that the chemical reaction brings about the deposition of an Ni—P or Ni—B matrix. This technique for deposition of nickel coverings is known per se, notably in the motor vehicle and aeronautical industries.

A bath consists of:

a nickel source. This is generally a nickel salt, in particular nickel chloride or sulphate;

an Ni++ reducing agent: the most commonly used reducing agents are alkaline hypophosphites such as sodium hypophosphite, or aminoboranes notably N-dimethylborane (DMBA) or N-diethylborane (DEAB), or alkaline borohydrides such as sodium borohydride;

an additive for better controlling the Ni deposit and limiting it to the surface intended to receive the deposit, often referred to as the catalytic surface; notably citric acid or glycolic acid can be used;

a buffer for controlling the pH, such as acetate, propionate or succinate buffers;

optionally a reaction accelerator, such as succinic acid, or

an inhibitor for limiting the reaction speed, for example a molybdate or a sulphurous compound such as thiourea.

In hypophosphite-based baths, the chemical mechanisms can be summarised, non-exhaustively, by the following reactions:

(H2PO2)−+H2O→H++(HPO3)2−+2H (1)

Ni2++2H→Ni+2H+ (2)

(H2PO2)−+H→H2O+OH−+P (3)

(H2PO2)−+H2O→H++(HPO3)2−+H2 (4)

Amongst the products of the reaction, the following in particular should be noted:

the formation of H+, which leads to progressive lowering of the pH of the bath and the deposition speed and increases the P content of the deposit. In order to control the deposition speed and the P content, on the one hand buffers such as those mentioned above are used and, on the other hand, after periodic titration of the bath, the pH of the solution can be adjusted throughout the deposition step;

the formation of (HPO3)2−: its accumulation leads to the co-deposition of orthophosphites with Ni and P, giving a porous deposit with many internal stresses. The addition of citric acid increases the solubility of (HPO3)2− and avoids its deposition.

In hypophosphite-based baths, the temperature must be maintained between 80° C. and 95° C. On average, 5 kg of sodium hypophosphite are necessary to reduce 1 kg of Ni.

In aminoborane-based baths, operations can be carried out at a lower temperature, of the order of 60° C. to 75° C., and at values of pH between 5 and 9. The drop in pH, as a result of the deposition reaction, is less than in the case of hypophosphite baths and requires less correction. Accumulation of the reaction by-product (BO2)− has little effect on the Ni—B deposition process.

In borohydride-based baths, the pH must on the other hand be readjusted and maintained permanently above 12, for example by means of alkaline hydroxide, in order to avoid decomposition of the reagent. Borohydrides are the most powerful nickel reducing agents: 0.6 kg is sufficient to reduce 1 kg of nickel.

Examples of Baths EXAMPLE 1

Nickel chloride (45 g/l)

Sodium hypophosphite (11 g/l)

Ammonium chloride (50 g/l)

Sodium citrate (100 g/l)

At a pH=8.5-10 and a temperature=90° C.-95° C., the deposition speed is of the order of 10 pm/h

### EXAMPLE 2

Nickel sulphate (21 g/l)

Sodium hypophosphite (24 g/l)

Lactic acid (28 g/l)

Propionic acid (2.2 g/l)

At a pH=4-6 and a temperature=88° C.-95C, the deposition speed is of the order of 25 μm/h

### EXAMPLE 3

Nickel chloride (30 g/l)

DEAB (3 g/l)

Isopropanol (50 g/l)

Sodium citrate (10 g/l)

Sodium succinate (20 g/l)

At a pH=5-7 and a temperature=65° C., the deposition speed is 7-12 μm/h

### EXAMPLE 4

Nickel chloride (30 g/l)

DMAB (3-4.8 g/l)

Potassium acetate (18-37 g/l)

At a pH=5.5 and a temperature=70° C., the deposition speed is of the order of 7 to 12 μm/h

### EXAMPLE 5

Nickel chloride (21 g/l)

Sodium borohydride (0.4 g/l)

Sodium hydroxide (90 g/l)

1,2-Diaminoethane (90 g/l)

Thallium sulphate (0.4 g/l)

At a pH of 12.5-13 and a temperature of 90° C.-95° C., the deposition speed reaches 25-30 μm/h.

The operating conditions of the baths are preferably adjusted and maintained so that, in the covering, an Ni—P matrix comprises 5%-11% by weight of P, or an Ni—B matrix consists of 2%-6% by weight of B.

FIG. 1a depicts schematically a blade strip 1 wound with an insert strip 2 of non-catalytic material on a support wheel 3. FIG. 1b shows an enlarged detail view thereof, ready for treatment. Only the functional edge of the future blade remains clear of the winding of the insert strip, typically over a width of 5 mm to 15 mm. But this width can be smaller or larger than these values.

Throughout the whole duration of the co-deposition treatment, the support wheel 3 turns in order to improve the regularity of the deposit, as illustrated in FIG. 2, but at a sufficiently slow speed not to negatively affect the co-deposition process. The bath is maintained at constant temperature and continuously stirred (5) in order to keep the ceramic particles in suspension. The ceramic particles are chosen from amongst the particles wettable by the chemical bath, inert as regards the aforementioned constituents of the bath and essentially non-catalytic, that is to say the deposition of the nickel-based matrix takes place essentially on the surface of the blade strip and not on the surface of the particles in suspension. Particles of oxide of aluminium (alumina), zirconium, chromium, silicon carbide, of hardness generally between 8 and 9.5 (Mohs scale), are ceramics that can be used. Particles of other carbides or diamond can also be used. The quantity of particles put in suspension generally varies between 5% and 50% of the volume of the bath. For deposits of thickness generally between 30 μm and 500 μm, and more particularly 30 μm and 250 μm, particles of diameter between 0.5 μm and 10 μm are suitable. The proportion of particles in the bath is adjusted so as to obtain a proportion of particles in the covering between 5% and 40% by volume thereof.

The microphotographs of portions of covering of FIGS. 4a and 4b show that the distribution of particles in the covering is statistically homogeneous, from which there results a homogeneousness of the microscopic surface properties and notably a homogeneousness as regards the wear of the blade after a number of hours of service.

Microscopic examination of blade cross-sections, depicted schematically in FIG. 3a, also shows that the deposit faithfully follows the geometry of the blade, and that the thickness of the deposit is homogeneous. There is no excess thickness or lack of deposit at the corners of the steel blade; the deposit forms a roundness at these corners. The result of this is that it is not necessary to machine the blade after deposition in order to rectify the profile thereof. Polishing may however be performed.

The functional part covered by means of the co-deposition method has an Hv0.1 hardness of 500 to 700 units. However, heat treatment between 220° C. and 650° C. after co-deposition improves the hardness and the adhesion of the deposit to the substrate. The Hv0.1 hardness can reach 1100 units after heat treatment and can even exceed 1300 units (Hv0.1 designates the Vickers microhardness under a load of 0.1 kg).

An Ni—P deposit is amorphous after deposition. Heat treatment at a temperature between 220° C. and 260 C. leads to a start of phase transformation of the NiP deposit with the appearance of the Ni3P phase.

Heat treatment at a higher temperature, around 320° C. to 350° C., leads to crystallisation of the deposit, which thus loses its amorphous nature, and its transformation into a two-phase alloy. The Ni—P phase diagram shows a eutectic at 11% by weight of Ni. The choice of the percentage of P determines the mechanical characteristics of the deposit according to the proportion of the nickel and nickel phosphite phases.

This structural change is accompanied by an increase in the hardness of the deposit which changes from Hv0.1 ≈500-700 to values of Hv0.1 of at least 900 and generally ≧1000.

This structural change is also accompanied by a reduction in the ductility of the deposit and the corrosion resistance, owing to the drop in the percentage of P, due to the formation of nickel phosphite (see Example 7).

For the coating of papers, the range of 5≦% P≦10 appeared favourable for combining the ductility of nickel and the hardness of nickel phosphites and obtaining a deposit both hard and tenacious.

In other applications, the Ni—P deposit is most often used for its corrosion resistance. For this reason, heat treatment after deposition, which reduces the corrosion resistance, is avoided or else performed at fairly low temperatures, of around 260° C. to 270° C., which improve the hardness without reducing the corrosion resistance too much. For application to the coating of paper, the present inventors considered that the hardness and tenacity are the most important properties, the corrosion resistance being secondary; this is why, in order to improve the life of the coating blades covered with Ni—P/SiC composite according to the invention, it is preferable to adopt post-deposition heat treatment between 290° C. and 650° C., temperatures higher than the temperatures mentioned above. This temperature range and an appropriate % P (5≦% P≦10) make it possible to improve by diffusion the adhesion of the deposit to the substrate, to achieve the highest hardness while keeping sufficient tenacity for the deposit and without impairing the mechanical characteristics of the substrate essential to the satisfactory operation of the blades (see Example 8).

### EXAMPLE 7

Effect of heat treatment on the corrosion resistance in a 10% HCl solution.

With a 10.5% P deposit:

TABLE 1

| | | Corrosion speed |
|---|---|---|
| Heat treatment | Hv0.1 hardness | (μm/year) |
| None | 480 | 15 |
| 290° C./10 hr | 970 | 1400 |
| 400° C./1 hr | 1050 | 1200 |

### EXAMPLE 8

Effect of the temperature of the heat hardening treatments on the hardness of the NiP/SiC covering.

With a 7% P deposit:

1. Linear rise to 300 C. in 2 hours—maintenance for 8 hours at 300° C., lowering again to ambient temperature in 2 hours: the Hv0.1 hardness obtained is 1050.

2. Linear rise to 450° C. in 3 hours—maintenance for 1 hour at 450° C., lowering again to ambient temperature in 3 hours: the Hv0.1 hardness obtained is 1100.

The characteristics of the blades according to the invention can therefore be modified by the nature, granulometry and proportion of the ceramic grains in the matrix, the composition of the matrix itself and the post-deposition heat treatment. The properties of the blades according to the invention can therefore be adjusted considerably according to application; they can be close to both those of a non-covered steel blade and those of blades covered solely with ceramic, or else be different from both. The following examples show the comparative properties of a number of blades.

### EXAMPLE 9

Comparison of an Ni—P—SiC covered blade with a ceramic-covered blade and a non-covered steel blade, during coating in “scraping mode”.

Test Conditions:

On-line coating, coating head with ABC blade holder (BTG Kalle Inventing AB, Sweden)

Type of paper: fine paper

Paper advance speed: 768 m/min

Coating slip: 65% solid material (kaolin, CaCO₃)

Working angle: 20°

Coat weight: 10 g/m², “coated once”

Characteristics of the Ni—P—SiC blade: length 3700 mm, nominal thickness 0.457 mm, covering 70 μm

Comparison Blades:

a) “Duroblade” (TM of BTG Eclepens) ceramic blade of the same dimensions

b) Steel blade of the same dimensions

Results:

Life:

steel blade: 8 hours,

Ni—P—SiC covered blade: greater than 17 hours,

ceramic-covered blade: 24 hours.

The test with the Ni—P—SiC covered blade was stopped after 17 hours owing to failure of the coating machine while the blade was still not totally worn out.

### EXAMPLE 10

Comparison of a steel blade and an Ni—P—SiC covered blade in “smoothing mode”.

Test Conditions:

Voith coating machine in smoothing mode

coating speed: 324-340 m/min

blades used in top coating:

angle of the blade holder: 24°

working angle: 50 to 6.5°

coating slip type: 68% CaCO₃-based solid, viscosity 880 to 900 CPS

blades:

a) steel, length 4900 mm, nominal thickness 0.381 mm, 70 μm Ni—P—SiC covering

b) steel, length 4900 mm, nominal thickness 0.381 mm, non-covered.

Results: the total deposited coat weight is 21 g/m², comprising 12 g/M² in precoating and 9 g/m² in top coating; surface condition of the coated paper:

PPS roughness =1.03-1.36.

The coat weight remains almost constant, varying between 21 and 23 g/m², in 20 hours of operation with the Ni—P—SiC blade, whereas the coat weight remains constant and the surface condition of the coated paper acceptable for only 8 to 10 hours with the steel blade.

The life of the Ni—P—SiC covered blade is therefore twice that of the non-covered blade. It must be noted that, under these operating conditions, the ceramic-covered blades did not allow the required coated paper quality to be obtained.

### EXAMPLE 11

Comparison of an Ni—P—SiC covered blade with a “Duroblade” ceramic-covered blade marketed by BTG Eclépens S. A. and a commercially available chromium plated blade.

The steel substrates of the three types of blade all have the same dimensions, namely nominal thickness 0.508 mm, width 100 mm, length 780 mm. The blade according to the invention has a 30 μm thick Ni—P—SiC covering, the ceramic blade has a 150 micron thick covering and the chromium plated blade has a 50 μm thick chromium covering.

Test Conditions:

Inverted ABC blade holder, pressure blade with around 5 mm of the blade tip with Trelleborg type 65 PJ backing roll.

Blade angles: 30°

Paper: fine, chemical pulp, precoated at 112 g/m2, of Multiart Silk type

Coating slip: 63% solids, for a viscosity of 1000-1200 cps; the solid material comprises 30 parts clay (SPS) to 40 parts Kaolin ultrawhite (Engelhart), 30 parts HC 90 calcium carbonate (Omya), 14 parts DL 950 latex (Dow), 0.20 parts Kenores 1420 (Casco Nobel) and 0.30 parts CMC FF 10 carboxymethylcellulose (Metsa Serla).

The coating speed is maintained at 500 m/min for all the tests.

In a first test, the differential pressure is adjusted successively to 100, 200 and 300 kpa. FIG. 5 shows on the Y-axis the coating weight in g/m² obtained for the three types of blade, the differential pressure in kpa being on the X-axis. At these three differential pressures, it may be noted that the Ni—P—SiC blade allows a larger passage of coating slip than the other two materials, all other conditions being equal. The Ni—P—SiC blade therefore allows better control of the coat profile in the “crosswise direction”.

In a second test, a complete reel of paper was coated with each type of blade aiming at a uniform coat weight of 10 g/m². Under these conditions, it is more difficult to regulate a constant coat weight with the chromium plated blade than with the other two. Examination of the shape of the tip of the chromium plated blades shows that their geometry is not constant, hence a variability in the coat weight. The comparative roughness and smoothness tests of the paper give the results summarised in Table 2.

TABLE 2

| | Bendtsen | PPS |
|---|---|---|
| Blade type | smoothness | roughness |
| Ceramic | 14 | 1.41 |
| Ni-P-SiC | 16 | 1.69 |
| Chromium | 38 | 1.85 |

A qualitative test of the coverage of the fibres based on a Kroda ink test gives the following ranking:

1. Ni—P—SiC covered blade

2. BTG-Eclepens ceramic blade

3. Chromium plated blade

### EXAMPLE 12

Comparative test of coated paper production between coating blade according to the invention (Ni—P/SiC) and commercially available chromium plated blade.

Blades:

The steel substrates of the two types of blade all have the same dimensions, namely nominal thickness 0.508 mm, width 76.2 mm, length 3730 mm.

The blade according to the invention has a 70 micron thick Ni—P/SiC covering, the SiC particles of which are smaller than 5 microns.

The chromium plated blade has a 35 micron thick chromium covering.

All the blades are bevelled at 40 degrees.

Test Conditions:

Four-head off-line coating machine, tests on head 4 (felt side of the sheet formation), type MHI-Beloit S-matic, targeted coat weight: 10 g/m² per head.

A2 paper (art paper), final gsm 127.9 g/m², speed 950 m/min.

Coating slip: 62-63% solids, viscosity 700-800 cps.

Blade holder angle: 43.2 degrees.

Roll No 8, head 4 coated with chromium plated blade.

Roll No 11, head 4 coated with blade according to the invention.

After coating, the rolls are Super Calendered and then quantitative measurements are made in order to characterise the surface of the coated paper.

The results of the “felt” surface are written in Table 3 below:

TABLE 3

| | Roll 11 | | | Roll 8 | | |
|---|---|---|---|---|---|---|
| Sample position | CS | Middles | TS | CS | Middles | TS |
| Brightness (%) | 79 | 79 | 78 | 78 | 77 | 78 |
| (ISO 2813, 60 deg) | | | | | | |

| | | |
|---|---|---|
| Beck smoothness | 7200 +/− 500 | 6000 +/− 500 |
| (sec) (ISO 5627) | | |

CS = conductor side
TS = transmission side

It should be noted that, compared with the chromium plated blade in which the material is free of reinforcing phases, the results with the blade according to the invention are not only equivalent as regards brightness but surpass the chromium plated blade as regards surface smoothness.

These observations are entirely unexpected: a covering according to the invention presents, to microscopic analysis of the surface worn during the test, a topography of preferential erosion of the matrix as shown in FIG. 6a. These wear features are therefore not transferred to the surface of the coated paper. On the contrary, the worn chromium plated blade has practically no differential erosion of its surface, as shown in FIG. 6b, whereas the paper quality obtained is inferior.

The above tests show that the Ni—P—SiC covered blade has very good performance as regards the quality of the coated surface. It is surprising to note the excellent quality of the coated paper, notably the absence of micro-grooves, obtained with the Ni—P—SiC covered blades, even though this covering has discrete hard particles, showing on or protruding from the surface of the Ni—P matrix.

With a small thickness of Ni—P—SiC covering, of the order of 30 μm, the life of the blade is only slightly greater than that of a non-covered steel blade, while with a thicker covering, the life of a ceramic-covered blade is approached, with superior qualitative performance.

1. A method for manufacturing a coating blade, characterised in that it comprises a step of chemical co-deposition of a covering on the functional part of a steel blade strip, this covering comprising a nickel-based matrix and particles with a diameter of 0.5 μm to 10 μm, consisting of a material of hardness ≧8 (on the Mohs scale), and a subsequent step of segmenting the blade strip into coating blades.

2. A method according to claim 1, characterised in that the steel blade strip is submerged in a bath comprising at least a nickel salt, an Ni⁺⁺ reducing agent and particles in suspension, chosen from amongst ceramic, diamond or carbide particles wettable by the bath, inert as regards its constituents and substantially non-catalytic, the proportion of particles in the bath being between 5% and 50% by volume.

3. A method according to claim 2, characterised in that said Ni⁺⁺ reducing agent is chosen from amongst the hypophosphites, aminoboranes and borohydrides.

4. A method according to either of claim 2 or 3, characterised in that the bath also comprises particles of a solid lubricant in suspension, in particular particles of PTFE.

5. A method according to one of claims 1 to 4, characterised in that the blade strip is partially masked during the chemical co-deposition step in order to delimit the functional part to be covered.

6. A method according to claim 5, characterised in that the blade strip is wound on a support, in particular a support wheel, in a helical winding, the turns of the winding being separated from one another by an insert strip.

7. A method according to claim 6, characterised in that the support of the wound blade strip is maintained in a regulating movement during the co-deposition step.

8. A method according to one of claims 1 to 7, characterised in that the blade strip undergoes a preparation before the chemical co-deposition step, comprising cleaning and/or degreasing and/or brushing and/or electropolishing and/or an anodic attack.

9. A method according to one of claims 1 to 8, characterised in that, after the co-deposition step, the blade strip or the blade is subjected to heat treatment at a temperature above 220° C.

10. A method according to claim 9, characterised in that part of the heat treatment is performed between 290° C. and 650° C.

11. A coating blade having a covering comprising a nickel-based matrix and particles consisting of a material of hardness ≧8 on the Mohs scale, dispersed in said matrix, on the functional part of said blade.

12. A blade according to claim 11, characterised in that the matrix comprises 2% to 6% by weight of B.

13. A blade according to claim 11, characterised in that said matrix comprises 5% to 10% by weight of P.

14. A blade according to one of claims 11 to 13, characterised in that said covering contains 5% to 40% by volume of particles.

15. A blade according to one of claims 11 to 14, characterised in that said covering has an Hv0.1 hardness greater than 500.

16. A blade according to claim 15, characterised in that said covering has an Hv0.1 hardness ≧900.

17. A blade according to one of claims 11 to 16, characterised in that the material of said particles is chosen from amongst the oxides of aluminium, zirconium and chromium, silicon carbide and diamond.

18. A blade according to one of claims 11 to 17, characterised in that said covering has a thickness of 30 μm to 500 μm and, in particular, 30 μm to 250 μm.

19. A blade according to one of claims 11 to 18, characterised in that the covering also comprises particles of a solid lubricant, in particular particles of PTFE.

20. Use of a blade according to one of claims 11 to 19 for the coating of paper.
